(19) United States
(12) Patent Application Publication
(10) Pub. No.: US 2012/0192009 A1
(43) Pub. Date: Jul. 26, 2012

(54) TESTING METHOD AND TESTING SYSTEM OF KEYBOARD MODULE

(75) Inventor: PEI-MING CHANG, Taipei (TW)

(73) Assignee: Primax Electronics Ltd., Taipei (TW)

(21) Appl. No.: 13/074,289

(22) Filed: Mar. 29, 2011

(30) Foreign Application Priority Data
Jan. 21, 2011 (TW) 100102261

(51) Int. Cl. G06F 11/00

(52) U.S. Cl. 714/27; 714/E11.02

(57) ABSTRACT

A keyboard module testing system includes a computer host, a test frame, an encoding program and a main test program. The encoding program and the main test program are both installed in the computer host. The test frame is connected with the keyboard module and the computer host for generating plural key codes. The encoding program is used for assigning plural key codes to respective keys. According to the plural key codes, the main test program can recognize which key is being tested.

### CROSS-REFERENCES TO RELATED APPLICATIONS

This non-provisional application claims priority under 35 U.S.C. §119(a) to Patent Application No(s). 100102261 filed in Taiwan, R.O.C. on Jan. 21, 2011, the entire contents of which are hereby incorporated by reference.

### FIELD OF THE INVENTION

The present invention relates to a testing method and a testing system, and more particularly to a keyboard module testing method and a keyboard module testing system.

### BACKGROUND OF THE INVENTION

With rapid development of electronic and information industries, computers and the peripheral device thereof become essential parts in our daily lives. In addition to the working purposes, computers can be employed as amusement tools. In the computer systems, input devices play important roles for communicating the computer with the user. The common input devices of the computer systems include for example mice, keyboard devices, trackballs, and the like.

Take a keyboard device an input device for example. Hereinafter, the configurations of a conventional keyboard device will be illustrated with reference to FIG. 1. FIG. 1 is a schematic view illustrating the outward appearance of a conventional keyboard device. There are plural keys mounted on the surface of the keyboard device 1. These keys include for example ordinary keys 10, numeric keys 11 and function keys 12. When one or more keys are depressed by the user, a corresponding signal is issued to the computer, and thus the computer executes a function corresponding to the depressed key or keys. For example, when the ordinary keys 10 are depressed, corresponding English letters or symbols are inputted into the computer system. In addition, the function keys 12 (F1˜F12) can be programmed to cause corresponding application programs to provide certain functions.

Hereinafter, the internal circuitry of a conventional keyboard device will be illustrated with reference to FIG. 2. FIG. 2 is a schematic circuit diagram illustrating the internal circuitry of a conventional keyboard device. The keyboard device 1 includes a circuit board (not shown), a microprocessor 13 and a keyboard scanning matrix 14. The microprocessor 13 is connected with the keyboard scanning matrix 14. The other parts of the microprocessor 13 are well known in the art, and are not redundantly described herein. In addition, the keyboard scanning matrix 14 comprises plural scan input lines X0˜X7 and plural scan output lines Y0˜Y17, which crisscross with each other. The first terminals of the scan input lines X0˜X7 are connected with the microprocessor 13. In addition, the second terminals of the scan input lines X0˜X7 are connected with corresponding input pins (not shown) of the circuit board. The first terminals of the scan output lines Y0˜Y17 are connected with the microprocessor 13. In addition, the second terminals of the scan output lines Y0˜Y17 are connected with corresponding output pins (not shown) of the circuit board. Since the keyboard scanning matrix 14 includes 8 scan input lines (X0˜X7) and 18 scan output lines (Y0˜Y17), the keyboard scanning matrix 14 is an 8×18 scanning matrix. Each scan input line and each scan output line crisscross to define an intersection. In other words, the keyboard scanning matrix 14 has a total of 144 intersections correlating with plural keys on the surface of the keyboard device 1. That is, in a case that the keyboard device 1 has 144 keys, the internal circuitry of the keyboard device 1 should at least comprise 8 scan input lines and 18 scan output lines. When one of the keys of the keyboard device 1 is depressed, the tester may realize which key is depressed by examining the keyboard scanning matrix 14.

Conventionally, a keyboard module is installed on a notebook computer. Via the keyboard module, the user may input characters and symbols to the notebook computer. FIG. 3 is a schematic view illustrating the outward appearance of a conventional keyboard module. The outward appearance of the conventional keyboard module 2 is similar to that of the conventional keyboard device 1. There are plural keys 20 mounted on the surface of the conventional keyboard module 2. These keys 20 are classified into several types, e.g. ordinary keys 21, numeric keys 22 and function keys 23. Due to the size restriction of the notebook computer, the locations of the ordinary keys 21, the numeric keys 22 and the function keys 23 of the conventional keyboard module 2 are somewhat different from the conventional keyboard device 1. The functions of these keys of the conventional keyboard module 2 are similar to those of the conventional keyboard device 1, and are not redundantly described herein. It is noted that the conventional keyboard module 2 is not equipped with a keyboard scanning matrix. That is, the keys 20 of the conventional keyboard module 2 only have turning on/off functions similar to the common switches. Under this circumstance, if the key A of the conventional keyboard module 2 is depressed, the notebook computer is only able to realize that one of the keys 2 has been depressed, but fails to identify which key is the depressed key 20.

Hereinafter, a testing method of the conventional keyboard module 2 will be illustrated with reference to FIG. 4. FIG. 4 is a schematic circuit diagram illustrating the connection between the conventional keyboard module and plural light-emitting elements. As shown in FIG. 4, the keyboard module 2 is connected with twenty six light-emitting elements 25 through a flat cable 23 (see FIG. 3). The flat cable 23 has twenty six pins. These pins are sequentially denoted as A0, A1, A2, A3, A4, A5, A6, A7, B0, B1, B2, B3, B4, B5, B6, B7, B8, B9, B10, B11, B12, B13, B14, B15, B16 and B17. These pins are respectively connected with corresponding light-emitting elements 25, thereby collectively defining a keyboard scanning matrix.

After the keyboard module 2 is connected with the light-emitting elements 25, the tester may sequentially depress the keys 20 of the keyboard module 2 one by one. At the same time, the tester may check whether the corresponding light-emitting elements 25 illuminate in order to judge the operating conditions of the depressed keys 20. If a pair of light light-emitting elements 25 corresponding to the depressed key illuminate, the tester may judge that this key 20 passes the test. On the other hand, if one or two of the two light-emitting elements 25 corresponding to the depressed key do not illuminate, the tester may judge that this key 20 fails to pass the test.

The conventional method of testing the keyboard module, however, still has some drawbacks. For example, it is labor-intensive and time-consuming to sequentially depress the keys. Moreover, the keys may be erroneously depressed because of man-made carelessness, but it is difficult to find out the erroneously-depressed problem.

Therefore, there is a need of providing a keyboard module testing method and a keyboard module testing system for increasing the testing speed and minimizing the possibility of erroneously depressing keys.

### SUMMARY OF THE INVENTION

The present invention provides a keyboard module testing method and a keyboard module testing system for increasing the testing speed and minimizing the possibility of erroneously depressing keys.

The present invention also provides a keyboard module testing method and a keyboard module testing system by unifying the format of the key codes.

In accordance with an aspect of the present invention, there is provided a keyboard module testing system for testing a keyboard module. The keyboard module includes plural keys. The keyboard module testing system includes a computer host, a test frame, an encoding program and a main test program. The test frame is connected with the keyboard module and the computer host for generating plural key codes. The encoding program is installed in the computer host for sequentially assigning plural key codes to respective keys. When the keys are triggered, the key codes corresponding to the keys are generated. The key codes have the same format. The main test program is installed in the computer host for testing the keyboard module and judging whether all of the keys pass according to the key codes.

In an embodiment, after the encoding program is activated to sequentially assign the key codes to respective keys, the encoding program sequentially assigns plural key serial numbers to respective keys and generates plural conditional expressions corresponding to respective keys according to the key serial numbers and the key codes, wherein the plural conditional expressions collectively define a minor test program.

In an embodiment, if all of the key codes corresponding to respective keys are sequentially received by the main test program according to the minor test program, the keyboard module is considered as a qualified keyboard module. Whereas, if at least one of the keys is not received by the main test program within a predetermined time period, the keyboard module is considered as a failed keyboard module.

In an embodiment, each of the key codes includes a corresponding human interface device usage identification code (HID Usage ID), and each of the key codes has a format defined in a Keyboard device/Keypad Page.

In an embodiment, each of the key codes is eight bytes long, wherein the key serial codes are positive integers arranged in ascending order.

In an embodiment, the keyboard module testing system further includes a monitor, which is connected with the computer host for showing an encoding interface of the encoding program and a test interface of the main test program. The encoding interface includes a start key serial number setting field, a next key serial number display field, a key code display field, a start encoding selective item, a stop encoding selective item, a conditional expression generating selective item and an exit encoding selective item. The test interface includes a tested key field, a test key amount field and a test exit selective item.

In accordance with another aspect of the present invention, there is provided a keyboard module testing method for testing a keyboard module. The keyboard module includes plural keys. The keyboard module testing method includes the following steps. Firstly, plural key serial numbers and plural key codes are sequentially received, and the key serial numbers and the key codes are assigned to respective keys. According to the key serial numbers and the key codes, plural conditional expressions corresponding to respective keys are generated. Afterwards, the key codes corresponding to respective keys are received according to respective conditional expressions, and a judging step is performed to judge whether all of the keys pass according to the key codes, wherein the key codes have the same format.

In an embodiment, if all of the key codes are successively received, the keyboard module is considered as a qualified keyboard module. Whereas, if at least one of the keys is not received within a predetermined time period, the keyboard module is considered as a failed keyboard module.

In an embodiment, each of the key codes includes a corresponding human interface device usage identification code (HID Usage ID), and each of the key codes has a format defined in a Keyboard device/Keypad Page.

In an embodiment, each of the key codes is eight bytes long, wherein the key serial codes are positive integers arranged in ascending order.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic view illustrating the outward appearance of a conventional keyboard device;

FIG. 2 is a schematic circuit diagram illustrating the internal circuitry of a conventional keyboard device;

FIG. 3 is a schematic view illustrating the outward appearance of a conventional keyboard module;

FIG. 4 is a schematic circuit diagram illustrating the connection between the conventional keyboard module and plural light-emitting elements;

FIG. 5 is a flowchart illustrating a keyboard module testing method according to an embodiment of the present invention;

FIG. 6 is a schematic functional block diagram illustrating a keyboard module testing system according to an embodiment of the present invention;

FIGS. 7A, 7B, 7C and 7D schematically illustrate the contents of the encoding interface of the keyboard module testing system according to an embodiment of the present invention; and

FIGS. 8A, 8B, 8C, 8D and 8E schematically illustrate the contents of the test interface of the keyboard module testing system according to an embodiment of the present invention.

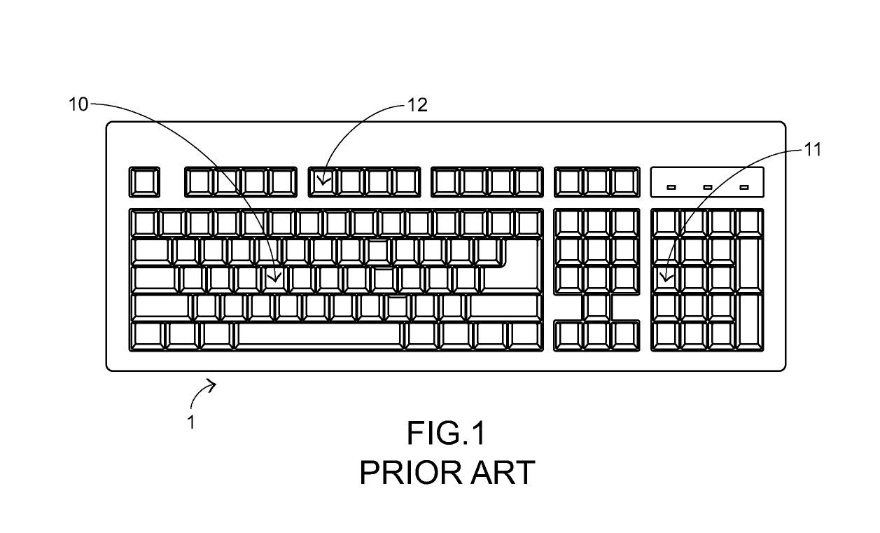

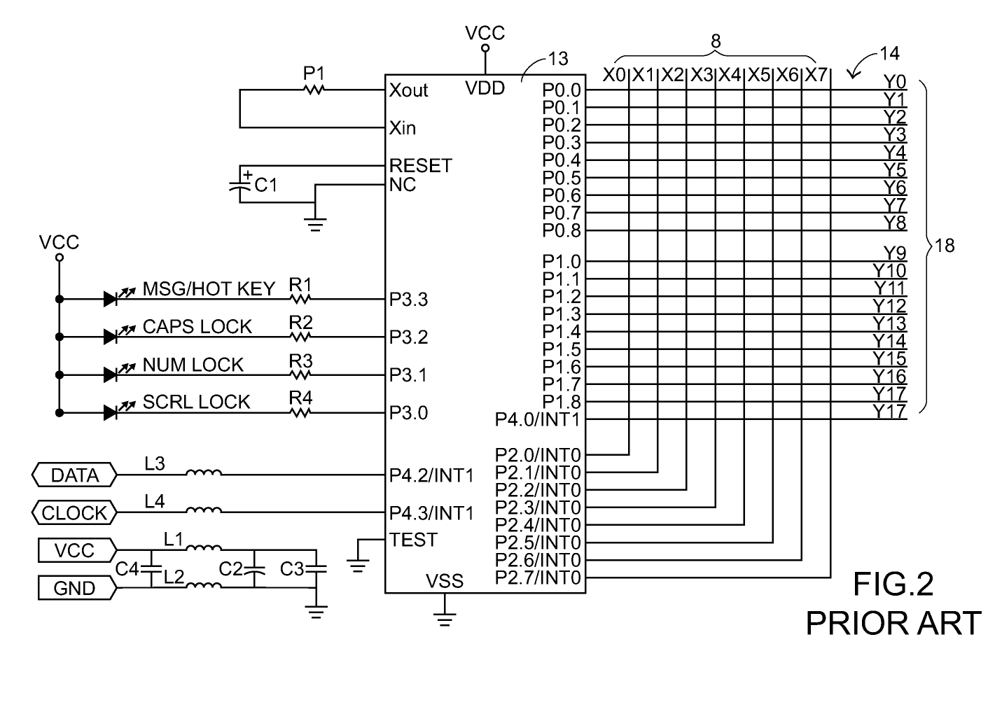

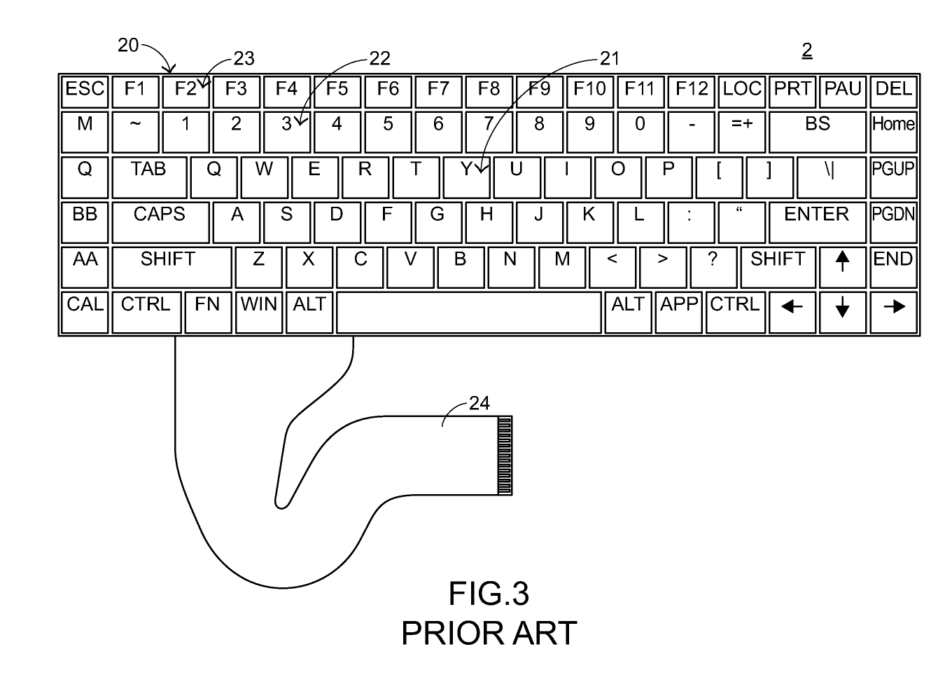

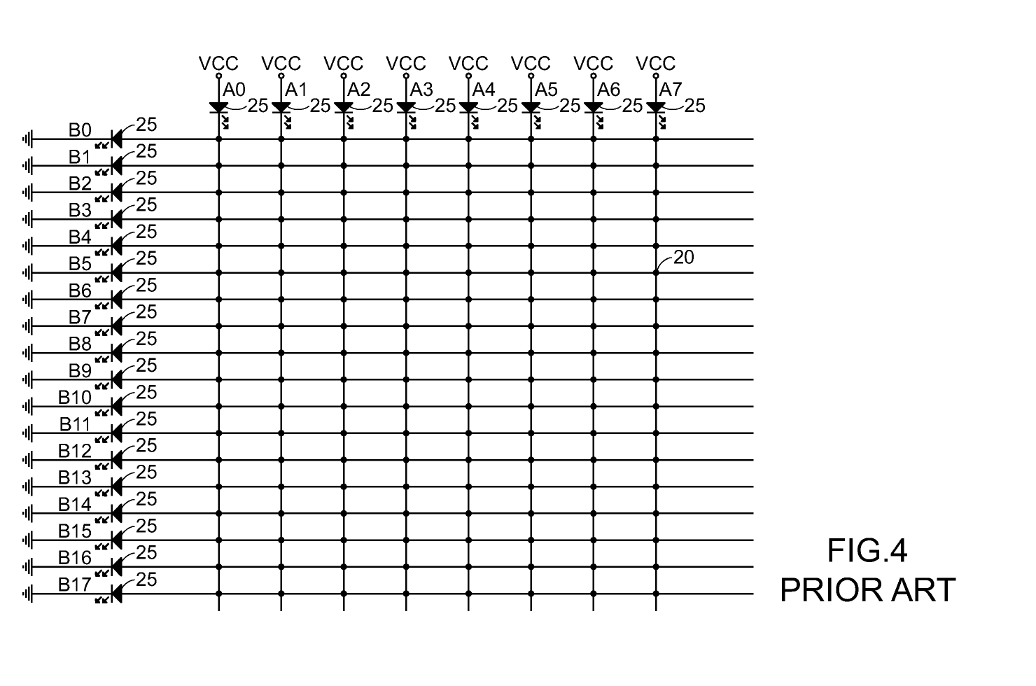

### DETAILED DESCRIPTION OF THE PREFERRED EMBODIMENT

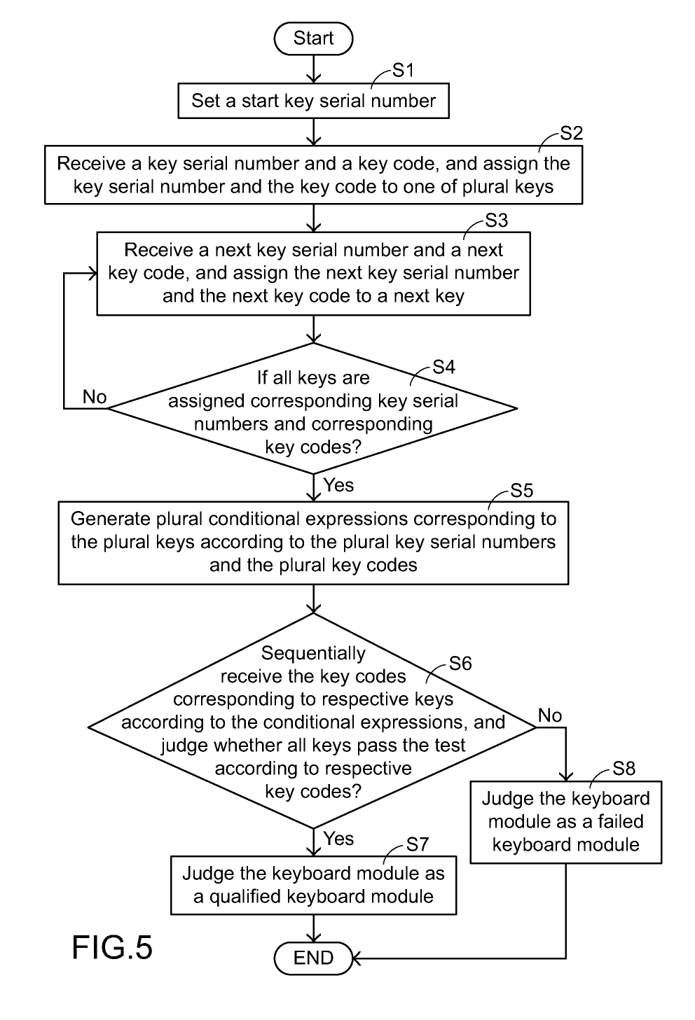

For obviating the drawbacks encountered from the prior art, the present invention provides a keyboard module testing method and a keyboard module testing system. FIG. 5 is a flowchart illustrating a keyboard module testing method according to an embodiment of the present invention. The keyboard module testing method includes the following steps. Firstly, in the step S1, a start key serial number is determined. Then, in the step S2, a key serial number and a key code are received, and the key serial number and the key code are assigned to one of plural keys. Then, in the step S3, a next key serial number and a next key code are received, and the next key serial number and the next key code are assigned to a next key. If all of the keys are assigned corresponding key serial numbers and corresponding key codes in the step S4, the step S5 is performed. In the step S5, plural conditional expressions corresponding to the plural keys are generated according to the plural key serial numbers and the plural key codes. Then, the step S6 is performed to sequentially receive the key codes corresponding to respective keys according to the conditional expressions and judge whether all keys pass the test according to respective key codes. If all of the keys pass the test, the keyboard module is considered as a qualified keyboard module in the step S7. Whereas, if not all of the keys pass the test, the keyboard module is considered as a failed keyboard module in the step S8.

Otherwise, if not all of the keys are assigned corresponding key serial numbers and corresponding key codes in the step S4, the step S3 and the step S4 are repeatedly done until all of the keys are assigned corresponding key serial numbers and corresponding key codes. After all of the keys are assigned corresponding key serial numbers and corresponding key codes, the step S5 is performed. If all key codes are received in the step S6, the keyboard module is considered as a qualified keyboard module in the step S7. Meanwhile, the keyboard module testing method is ended. Whereas, if not all of the keys are received by the main test program within a predetermined time period, the keyboard module is considered as a failed keyboard module, and then the keyboard module testing method is ended.

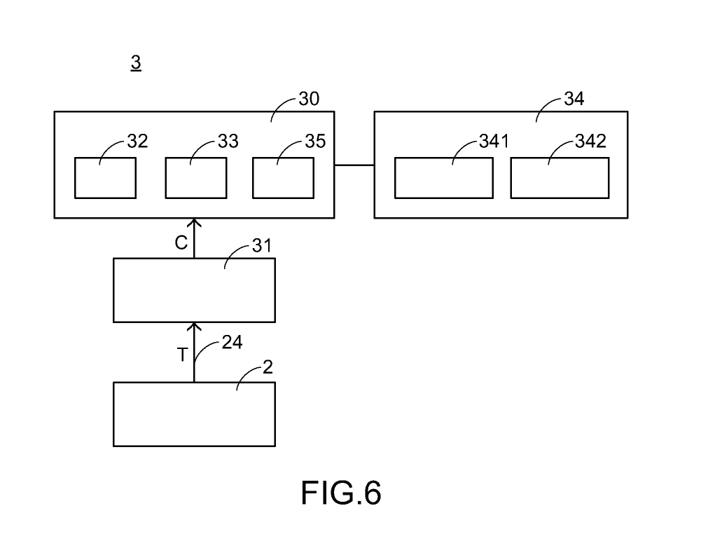

FIG. 6 is a schematic functional block diagram illustrating a keyboard module testing system according to an embodiment of the present invention. The keyboard module testing system 3 of the present invention is used for testing a keyboard module, for example the conventional keyboard module 2. The keyboard module testing system 3 comprises a computer host 30, a test frame 31, an encoding program 32, a main test program 33 and a monitor 34. The test frame 31 is connected with the computer host 30. The test frame 31 may generate plural key codes C. Through the flat cable 24, the keyboard module 2 is connected with the test frame 31. In this embodiment, the plural key codes C are generated by a microprocessor of the test frame 31. The encoding program 32 is installed in the computer host 30 for encoding the plural keys of the keyboard module 2. The main test program 33 is also installed in the computer host 30 for testing the keyboard module 2. The monitor 34 is connected with the computer host 30 for showing an encoding interface 341 of the encoding program 32 and a test interface 342 of the main test program 33.

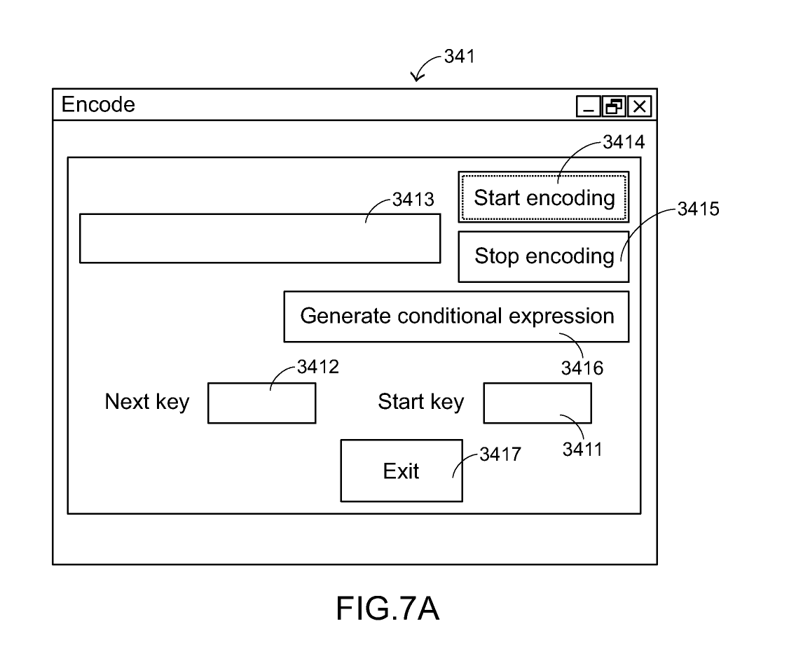

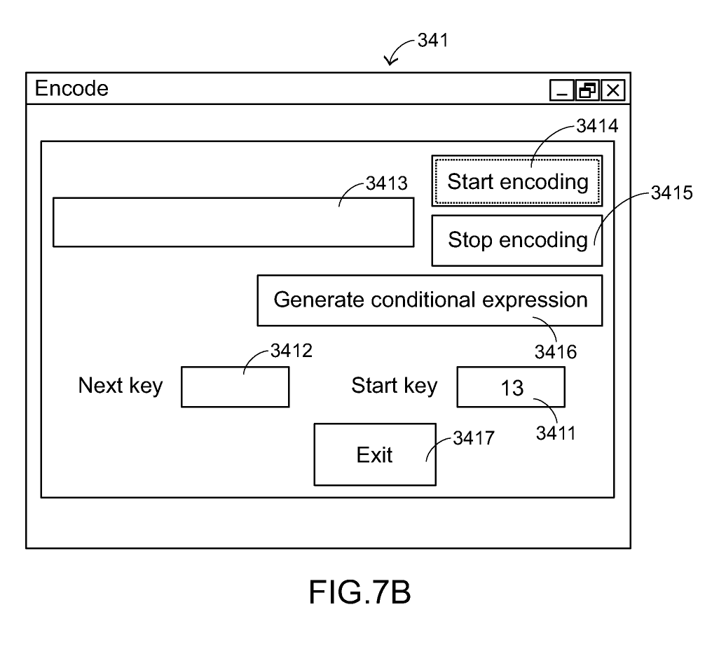

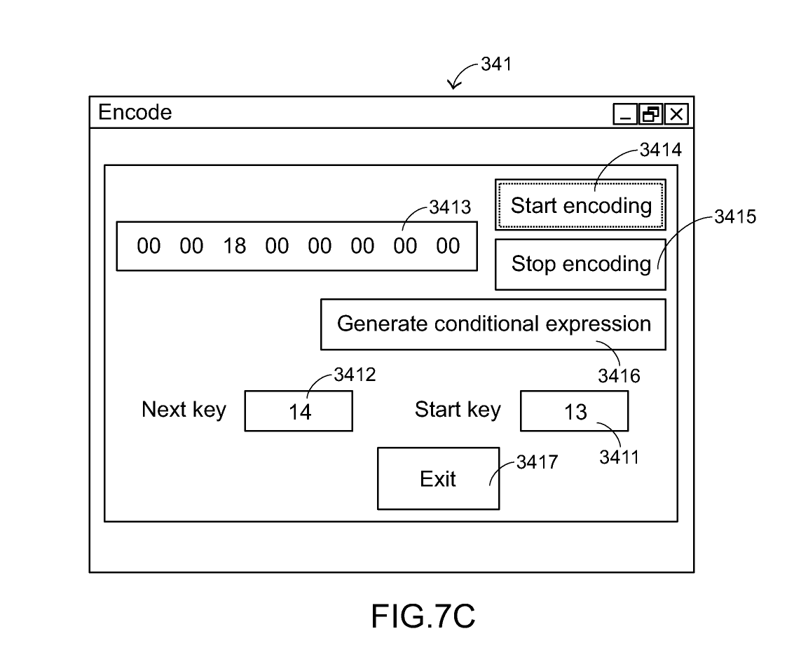

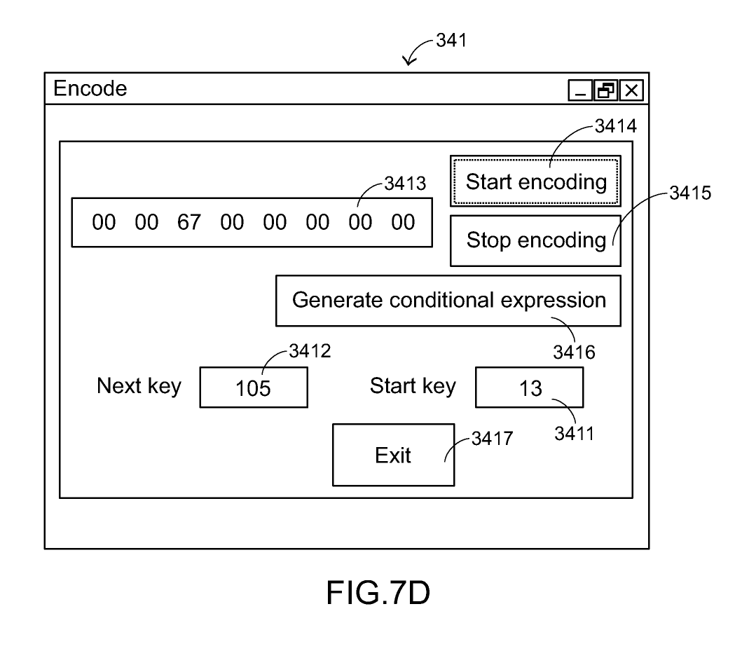

Hereinafter, the encoding interface 341 of the encoding program 32 will be illustrated with reference to FIG. 7A. FIG. 7A schematically illustrates the contents of the encoding interface of the keyboard module testing system according to an embodiment of the present invention. The encoding interface 341 comprises a start key serial number setting field 3411, a next key serial number display field 3412, a key code display field 3413, a start encoding selective item 3414, a stop encoding selective item 3415, a conditional expression generating selective item 3416 and an exit encoding selective item 3417. The start key serial number setting field 3411 is used for setting the start key serial number of the plural key serial number. The next key serial number display field 3412 is used for showing the next assigned key serial number. The key code display field 3413 is used for showing the assigned key code. By clicking the start encoding selective item 3414, the encoding task is started. By clicking the stop encoding selective item 3415, the encoding task is stopped. By clicking the conditional expression generating selective item 3416, the key conditional expressions corresponding to the encoded keys are generated. By clicking the exit encoding selective item 3417, the encoding interface 341 is closed.

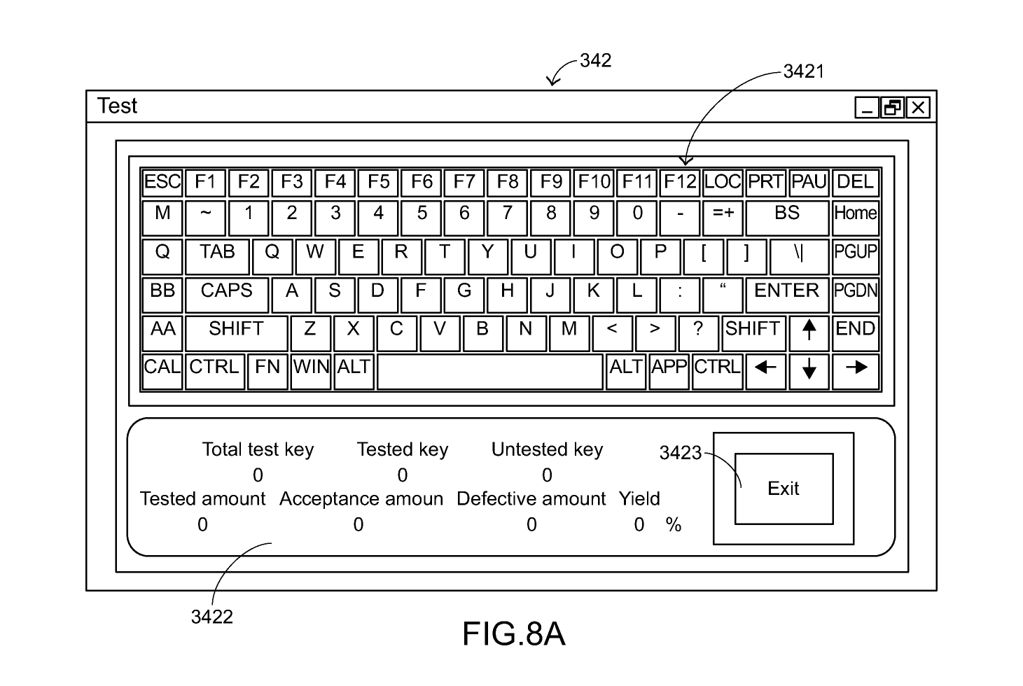

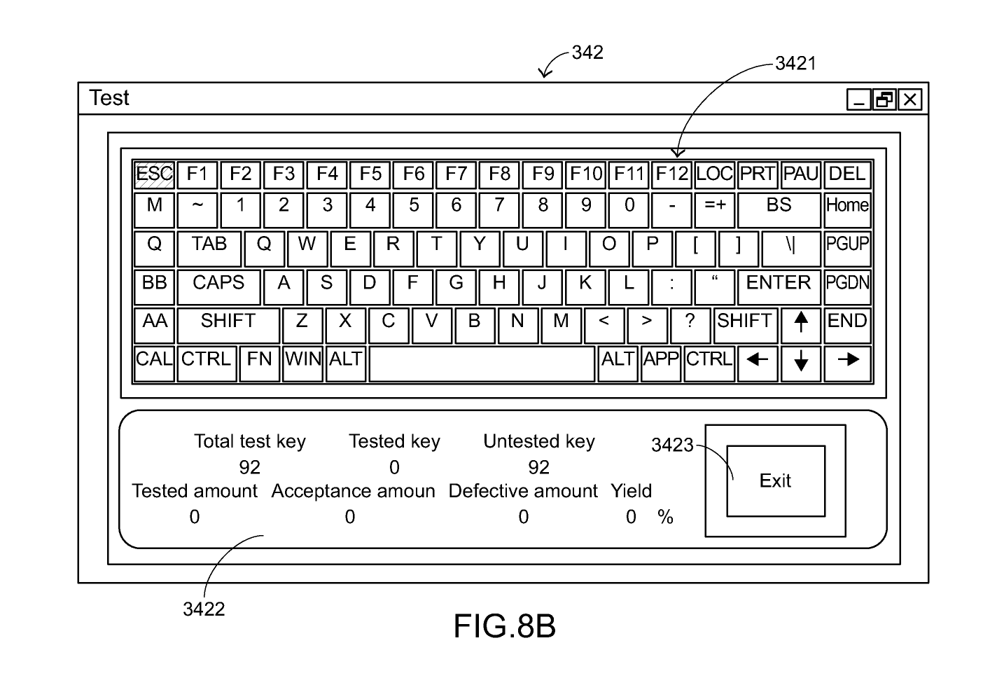

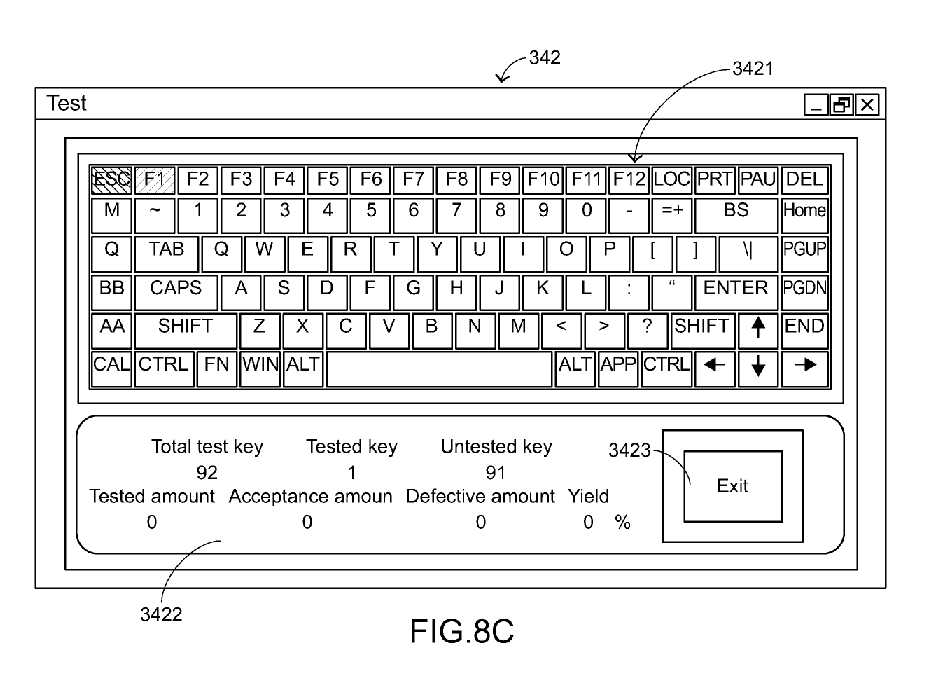

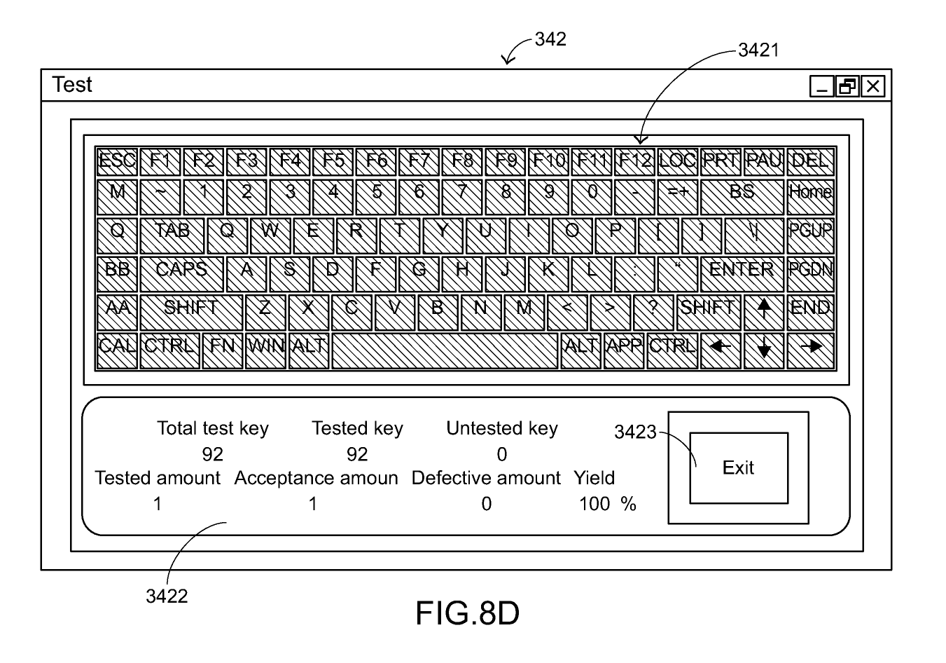

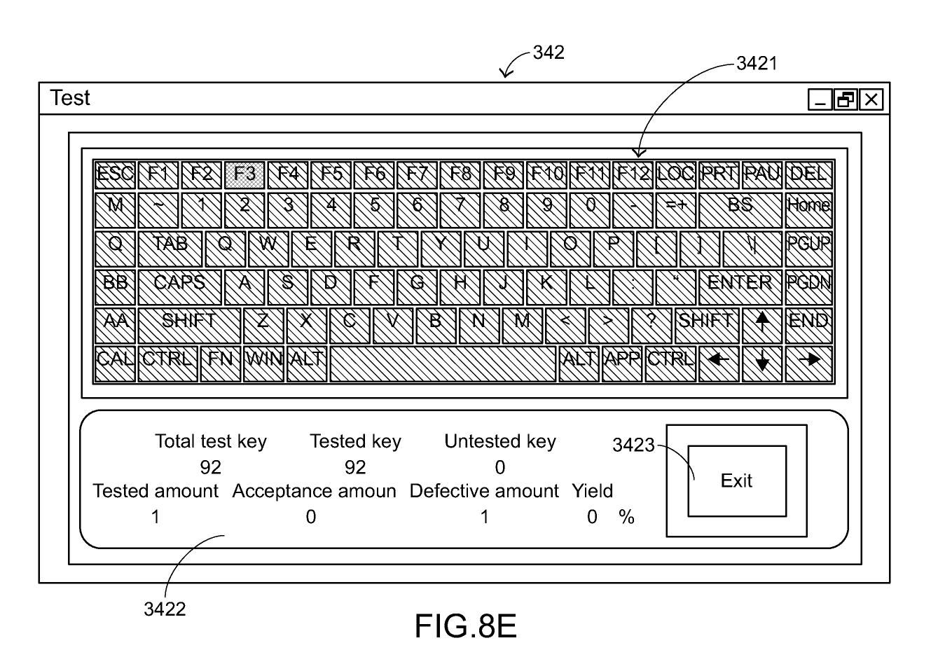

Hereinafter, the test interface 342 of the main test program 33 will be illustrated with reference to FIG. 8A. FIG. 8A schematically illustrates the contents of the test interface of the keyboard module testing system according to an embodiment of the present invention. The test interface 342 comprises a tested key field 3421, a test key amount field 3422 and a test exit selective item 3423. The tested key field 3421 is used for showing the plural keys of the keyboard module 2, thereby indicating the test status of the plural keys of the keyboard module 2. The test key amount field 3422 is used for indicating the total test key amount, the tested key amount, the untested key amount, the tested keyboard module amount, the total acceptance amount, the total defective amount and the yield. By clicking the test exit selective item 3423, the test interface 342 is closed. As shown in FIG. 8A, the tested key field 3421 and the test key amount field 3422 of the test interface 342 are both in the initial statuses. In this situation, the regions of the tested key field 3421 corresponding to the plural keys of the keyboard module 2 are marked with a first color (e.g. a gray color).

In this embodiment, the plural keys of the keyboard module 2 are tested in the order of the Esc key, the F1 key, the F2 key, . . . , the down arrow key and the right arrow key. In addition, the start key serial number is set as “13”.

The keyboard module testing system 3 will be illustrated in more details as follow. After the architecture of the keyboard module testing system 3 is established, the encoding program 32 is activated, and thus the encoding interface 341 is shown on the monitor 34. Firstly, the start key serial number is inputted into the start key serial number setting field 3411 of the encoding interface 341. The start key serial number is the start serial number of the plural key serial numbers (see the step S1 in FIG. 5). In this embodiment, the start key serial number is set as “13” (see FIG. 7B). Then, by depressing a first key (e.g. the Esc key) of the keyboard module 2, a key triggering signal T is generated and transmitted to the test frame 31. In response to the key triggering signal T, the test frame 31 generates and transmits a key code C to the computer host 30. After the key code C is received by the computer host 30, the encoding program 32 assigns a key serial number to the key code C. That is, the key serial number and the key code C are assigned to the depressed key (see the step S2 in FIG. 5). As shown in FIG. 7C, the key code C assigned to the key (e.g. the Esc key) is “00 00 18 00 00 00 00 00”, and the key serial number shown in the next key serial number display field 3412 is changed from “13” to “14”.

After the key serial number has been assigned, by depressing a next key (e.g. the F1 key), a next key triggering signal T is generated and transmitted to the test frame 31. In response to the next key triggering signal T, the test frame 31 generates and transmits a corresponding key code C to the computer host 30. After the key code C is received by the computer host 30, the encoding program 32 assigns a next key serial number (the next key serial number is “14” in this embodiment) and the key code C to the next key (see the step S3 in FIG. 5). Then, the step S4 is performed to judge whether all keys are assigned corresponding key serial numbers and corresponding key codes C (see the step S4 in FIG. 5). If the condition of the step S4 is not satisfied, the step S3 and the step S4 are repeatedly done. Whereas, if all keys (92 keys) of the keyboard module 2 are assigned corresponding key serial numbers and corresponding key codes C, by clicking the conditional expression generating selective item 3416 of the encoding interface 341, the encoding program 32 generate plural conditional expressions corresponding to the plural keys according to the plural key serial numbers and the plural key codes C. These conditional expressions collectively define a minor test program 35 (see the step S5 in FIG. 5). As shown in FIG. 7D, the key code C assigned to the last key (e.g. the right arrow key) is “00 00 67 00 00 00 00 00”, which is shown in the key code display field 3413. At the same time, the key serial number shown in the next key serial number display field 3412 is “105”. In accordance with the present invention, the plural key codes C include corresponding human interface device usage identification codes (HID Usage IDs). In addition, each key code C has a format defined in the Keyboard device/Keypad Page (0x07) and is eight bytes long.

It is noted that each of said key codes C is set to be consisted of seven codes “00” and a HID Usage ID. For example, the key code C corresponding to the Esc key includes a HID Usage ID “18” and several codes “00”. In such way, all key codes C are eight bytes long, but all key codes C are different. Typically, the key corresponding to the HID Usage ID “18” is the U key. However, the key code corresponding to the Esc key is “00 00 18 00 00 00 00 00”. That is, the key codes C in the present invention are only used to recognize respective keys of the keyboard module 2, and are not correlated with the HID Usage IDs known in the art.

Moreover, in the operating system of the computer provided by Microsoft Corporation, the key codes of the keyboard are defined in four types, i.e. a Generic Desktop Page (0x01), a Keyboard device/Keypad Page, a LED Page (0x08) and Consumer Page (0x0C). The Generic Desktop Page (0x01) is two bytes long. The Keyboard device/Keypad Page is eight bytes long. The Consumer Page is three to tens of bytes long. Since the keyboard module 2 contains no LED, the LED Page may be negligible. If the key codes defined by Microsoft Corporation are assigned to respective keys, the formats of these key codes become confused and complicated. Under this circumstance, since the most resources of the computer host 30 are occupied, the reading speed of the computer host 30 is reduced. For enhancing the speed of processing the key codes by the computer host 30, the key codes C generated by the test frame 31 are defined in the Keyboard device/Keypad Page and unified to be eight bytes long. Since the key codes C read by the computer host 30 have the same format, the processing speed will be enhanced.

Please refer to the keyboard module testing process again. After the minor test program 35 is generated, the minor test program 35 is activated by the main test program 33 and the test interface 342 is also shown on the monitor 34. Moreover, according to the plural conditional expressions of the minor test program 35, the sequence of testing the plural keys is acquired by the main test program 33. As shown in FIG. 8B, the region of the tested key field 3421 of the test interface 342 corresponding to the Esc key is marked with a second color (e.g. a blue color). The rest of the keys of the tested key field 3421 are still marked with the first color (i.e. the gray color). The region of the key marked with the second color denotes that the key is being tested. In other words, the region of the key marked with the second color denotes the key that is assigned the start key serial number (i.e. “13”). Under this circumstance, as shown in the test key amount field 3422 of FIG. 8B, the total test key amount is changed from 0 to 92; the untested key amount is changed from 0 to 92; and the tested key amount, the tested keyboard module amount, the total acceptance amount, the total defective amount and the yield are all 0. When the Esc key of the keyboard module 2 is depressed, the key code C corresponding to the Esc key (i.e. “00 00 18 00 00 00 00 00”) is generated and transmitted to the computer host 30. By checking whether the key code C is received, the main test program 33 of the computer host 30 will judge whether the key passes the test (see the step S6 in FIG. 5).

After the key code C corresponding to the Esc key is received by the main test program 33 and the main test program 33 judges that the Esc key passes the test, the region of the tested key field 3421 of the test interface 342 corresponding to Esc key is marked with a third color (e.g. a green color) to indicate the Esc key has passed the test. At the same time, the next to-be-tested key (i.e. the F1 key) is changed from the first color (i.e. the gray color) to the second color (i.e. the blue color) to indicate that the F1 key is being tested. The rest of the keys of the tested key field 3421 are still marked with the first color (i.e. the gray color). Under this circumstance, as shown in the test key amount field 3422 of FIG. 8C, the total test key amount is still 92; the tested key amount is changed from 0 to 1; the untested key amount is changed from 92 to 91; and the tested keyboard module amount, the total acceptance amount, the total defective amount and the yield are all 0.

Next, according to sequence of the plural conditional expressions of the minor test program 35, the plural keys of the keyboard module 2 are sequentially tested by the main test program 33. After all of the keys have been tested, if all of the key codes C are successively received by the main test program 33, the main test program 33 judges that the keyboard module 2 is a qualified keyboard module (see the step S7 in FIG. 5). Meanwhile, the regions of the tested key field 3421 of the test interface 342 corresponding to all keys are marked with the third color (i.e. the green color) to indicate all keys have passed the test. Under this circumstance, as shown in the test key amount field 3422 of FIG. 8D, the total test key amount is still 92; the tested key amount is changed to 92; the untested key amount is changed to 0; the tested keyboard module amount is changed to 1; the total acceptance amount is changed to 1; the total defective amount is still 0, and the yield is changed to 100%. Meanwhile, the process of testing the keyboard module 2 is terminated.

On the other hand, during the process of testing the keyboard module 2 by the main test program 33 according to conditional expressions of the minor test program 35, if at least one of the key codes C is not received within a predetermined time period (e.g. 10 seconds), the region of the tested key field 3421 of the test interface 342 corresponding to this key is marked with a fourth color (e.g. a red color) by the main test program 33. The region of the key marked with the fourth color denotes that the key fails to pass the test. The next key is continuously tested by the above testing procedures. Until all keys of the keyboard module 2 are tested, the keyboard module 2 is considered as a failed keyboard module. Meanwhile, as shown in FIG. 8E, the region of the tested key field 3421 of the test interface 342 corresponding to the F3 key is marked with the fourth color (i.e. the red color), but the rest of the keys of the tested key field 3421 are still marked with the third color (i.e. the green color). In other words, only the F3 key fails to pass the test. Under this circumstance, as shown in the test key amount field 3422 of FIG. 8E, the total test key amount is still 92; the tested key amount is changed to 92; the untested key amount is changed to 0; the tested keyboard module amount is changed to 1; the total acceptance amount is still 0; the total defective amount is changed to 1; and the yield is changed to 0%. Meanwhile, the process of testing the keyboard module 2 is terminated.

From the above description, in the keyboard module testing method and the keyboard module testing system of the present invention, the plural key codes generated by the test frame are assigned to respective keys of the keyboard module. During the process of testing the keyboard module, the main test program can recognize which key is being tested according to the key codes. Moreover, by assigning plural key serial numbers and plural key codes to respective keys, plural conditional expressions are generated. According to sequence of receiving the key codes in the plural conditional expressions, the sequence of testing the plural keys will be determined. Moreover, during the testing process, the tested key field of the test interface can indicate the status of the key that is being tested, thereby prompting the tester. Since the test interface used in the keyboard module testing method and the keyboard module testing system of the present invention have the function of guiding the tester to test the keyboard module, the possibility of erroneously depressing the keys will be minimized. That is, the test failure problem will be solved.

Moreover, during the testing process, if the test interface indicates that the F1 key is being tested but the F2 key is erroneously depressed, the keyboard module testing system still waits for receiving the key code corresponding to the F1 key, rather than the key code corresponding to the F2. That is, even if the key is erroneously depressed during the testing process, the test failure problem is not incurred. Since the keyboard module testing method and the keyboard module testing system of the present invention have the function of guiding the tester to test the keyboard module, the testing speed will be enhanced.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A keyboard module testing system for testing a keyboard module, said keyboard module comprising plural keys, said keyboard module testing system comprising:
a computer host;
a test frame connected with said keyboard module and said computer host for generating plural key codes;
an encoding program installed in said computer host for sequentially assigning plural key codes to respective keys, wherein when said keys are triggered, said key codes corresponding to said keys are generated, wherein said key codes have the same format; and
a main test program installed in said computer host for testing said keyboard module and judging whether all of said keys pass according to said key codes.

2. The keyboard module testing system according to claim 1 wherein after said encoding program is activated to sequentially assign said key codes to respective keys, said encoding program sequentially assigns plural key serial numbers to respective keys and generates plural conditional expressions corresponding to respective keys according to said key serial numbers and said key codes, wherein said plural conditional expressions collectively define a minor test program.

3. The keyboard module testing system according to claim 2 wherein if all of said key codes corresponding to respective keys are sequentially received by said main test program according to said minor test program, said keyboard module is considered as a qualified keyboard module, wherein if at least one of said keys is not received by said main test program within a predetermined time period, said keyboard module is considered as a failed keyboard module.

4. The keyboard module testing system according to claim 2 wherein each of said key codes includes a corresponding human interface device usage identification code (HID Usage ID), and each of said key codes has a format defined in a Keyboard device/Keypad Page.

5. The keyboard module testing system according to claim 4 wherein each of said key codes is eight bytes long, wherein said key serial codes are positive integers arranged in ascending order.

6. The keyboard module testing system according to claim 1 further comprising a monitor, which is connected with said computer host for showing an encoding interface of said encoding program and a test interface of said main test program, wherein said encoding interface includes a start key serial number setting field, a next key serial number display field, a key code display field, a start encoding selective item, a stop encoding selective item, a conditional expression generating selective item and an exit encoding selective item, wherein said test interface includes a tested key field, a test key amount field and a test exit selective item.

7. A keyboard module testing method for testing a keyboard module, said keyboard module comprising plural keys, said keyboard module testing method comprising steps of:
sequentially receiving plural key serial numbers and plural key codes, and assigning said key serial numbers and said key codes to respective keys;
generating plural conditional expressions corresponding to respective keys according to said key serial numbers and said key codes; and
sequentially receiving said key codes corresponding to respective keys according to respective conditional expressions, and judging whether all of said keys pass according to said key codes, wherein said key codes have the same format.

8. The keyboard module testing method according to claim 7 wherein if all of said key codes are successively received, said keyboard module is considered as a qualified keyboard module, wherein if at least one of said keys is not received within a predetermined time period, said keyboard module is considered as a failed keyboard module.

9. The keyboard module testing method according to claim 7 wherein each of said key codes includes a corresponding human interface device usage identification code (HID Usage ID), and each of said key codes has a format defined in a Keyboard device/Keypad Page.

10. The keyboard module testing method according to claim 9 wherein each of said key codes is eight bytes long, wherein said key serial codes are positive integers arranged in ascending order.
